(19) United States
(12) Patent Application Publication
(10) Pub. No.: US 2026/0368788 A1
(43) Pub. Date: Nov. 19, 2026

(54) ELECTRONIC DEVICE AND METHOD FOR PROVIDING TRANSACTION ENVIRONMENT FOR BOOSTING SERVICE

(71) Applicant: NC Corporation, Seongnam-si (KR)

(72) Inventors: Jihyun Kim, Seongnam-si (KR); Jiyoung Seok, Seongnam-si (KR); Euijoon Son, Seongnam-si (KR); Jiyoung Son, Seongnam-si (KR); Dongsoo Lee, Seongnam-si (KR); Dongwook Cho, Seongnam-si (KR)

(73) Assignee: NC Corporation, Seongnam-si (KR)

(21) Appl. No.: 19/726,085

(22) Filed: Jun. 30, 2026

Related U.S. Application Data
(63) Continuation of application No. PCT/KR2024/000117, filed on Jan. 3, 2024.

(51) Int. Cl. G06Q 30/0601; A63F 13/46; A63F 13/56; A63F 13/792

(52) U.S. Cl. CPC G06Q 30/0603; A63F 13/46; A63F 13/56; A63F 13/792

(57) ABSTRACT

This electronic device may comprise: a display; a communication circuit; and a processor. The processor may be configured to display, through the display, a user interface (UI) for a player character (PC) corresponding to a user of the electronic device to register sales of an agency service for another PC of another user. The processor may be configured to, on the basis of receiving a user input for registering the agency service in the server, the user input including information about a region in which the agency service is provided within a virtual space provided through a server and/or information about the price of the agency service, request, through the communication circuit, the server to register in an exchange including a list of one or more agency services for a transaction of the agency service.

### CROSS-REFERENCE TO RELATED APPLICATION(S)

This application is a continuation of International Application No. PCT/KR2024/000117 filed on Jan. 3, 2024, with the Ministry of Intellectual Property as the receiving Office, which claims the benefit of priority under 35 U.S.C. § 365(c). The disclosure of the prior application is incorporated by reference herein in its entirety.

### BACKGROUND

### 1.Field

Various embodiments disclosed in the present document relate to an electronic device and a method for providing a transaction environment for a boosting service.

### 2. Description of Related Art

A server providing a game service may provide a service for a transaction of a virtual item between users. For example, the server may provide a virtual marketplace for a transaction of a virtual item. A seller may register a virtual item to be sold in the virtual marketplace. A purchaser may check the virtual item registered in the marketplace and determine purchase of the virtual item. For example, the virtual marketplace may provide information related to the virtual item to be sold. For example, the information related to the virtual item may include a name, a type, an assigned stat, and/or an assigned special effect.

### SUMMARY

Aspects of the disclosure are to address at least the above-mentioned problems and/or disadvantages and to provide at least the advantages described below. Accordingly, an aspect of the disclosure is to provide a server for restricting abnormal access and a method thereof.

Additional aspects will be set forth in part in the description which follows and, in part, will be apparent from the description, or may be learned by practice of the presented embodiments.

A low-skilled (or low-experience) user may need help of a high-skilled (or high-experience) user for growth of a player character (PC) and/or progress of a quest on a virtual space. In addition, the high-skilled (or high-experience) user may receive a predetermined fee and help the low-skilled (or low-experience) user. However, a transaction contract between the low-skilled (or low-experience) user and the high-skilled (or high-experience) user concluded outside the virtual space may rely on good faith of both parties, and damage to another user may occur by any one user. Therefore, a method for providing a safe and reliable connection opportunity between the low-skilled (or low-experience) user and the high-skilled (or high-experience) user may be required.

An electronic device may comprise a display, a communication circuit, and a processor. The processor may be configured to display, via the display, a user interface (UI) for registering a sale of an agency service for another player character (PC) of another user by a PC corresponding to a user of the electronic device. The processor may be configured to, based on receiving a user input for registering, in a server, the agency service including information on a region in a virtual space provided through the server in which the agency service is provided and/or information on a price of the agency service, request, via the communication circuit, the server to register the agency service in a marketplace including a list of one or more agency services, for a transaction of the agency service.

A method performed by an electronic device may comprise displaying, via a display of the electronic device, a user interface (UI) for registering a sale of an agency service for another player character (PC) of another user by a PC corresponding to a user of the electronic device. The method may comprise, based on receiving a user input for registering, in a server, the agency service including information on a region in a virtual space provided through the server in which the agency service is provided and/or information on a price of the agency service, requesting, via a communication circuit of the electronic device, the server to register the agency service in a marketplace including a list of one or more agency services, for a transaction of the agency service.

An electronic device may comprise a display, a communication circuit, and a processor. The processor may display, via the display, a user interface (UI) including a list of one or more agency services registered in a server for a transaction, on a screen including at least a portion of a virtual space including a player character (PC) corresponding to a user of the electronic device. The processor may be configured to receive a user input for purchasing one agency service among the one or more agency services in the list. The processor may be configured such that the PC receives the agency service via another PC of another user who registered the agency service, based on receiving the user input.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is an exemplary block diagram of an electronic device in a network environment, according to an embodiment.

FIG. 2A is a flow chart illustrating operations of an electronic device and a server according to an embodiment.

FIG. 2B illustrates a UI displayed on a display of an electronic device according to an embodiment.

FIG. 3A is a flow chart illustrating operations of an external electronic device and a server according to an embodiment.

FIG. 3B illustrates a UI displayed on a display of an external electronic device according to an embodiment.

FIG. 3C illustrates a screen displayed on a display of an external electronic device according to an embodiment.

FIG. 3D illustrates a UI displayed on a display of an external electronic device according to an embodiment.

FIG. 3E illustrates a UI displayed on a display of an electronic device according to an embodiment.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

An electronic device according to various embodiments disclosed in the present document may be a device in various forms. The electronic device may include, for example, a portable communication device (e.g., a smartphone), a computer device, and a portable multimedia device. The electronic device according to an embodiment of the present document is not limited to the above-described devices.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

Specific structural or functional descriptions of embodiments according to the concept of the present invention disclosed in the present specification are merely illustrated for the purpose of describing the embodiments according to the concept of the present invention, and the embodiments according to the concept of the present invention may be implemented in various forms and are not limited to the embodiments described in the present specification.

Since the embodiments according to the concept of the present invention may be modified in various ways and may have various forms, the embodiments will be illustrated in the drawings and described in detail in the present specification. However, this is not intended to limit the embodiments according to the concept of the present invention to specific disclosed forms, but includes modifications, equivalents, or substitutes that are included in the spirit and the scope of the present invention.

Terms such as ‘first’ and ‘second’ may be used to describe various elements, but the elements should not be limited by the terms. The terms are used only for the purpose of distinguishing one element from another, and for example, without departing from the scope of the concept of the present invention, a first element may be referred to as a second element, and similarly, the second element may also be referred to as the first element.

When an element is referred to as being “connected” or “coupled” to another element, it should be understood that the element may be directly connected or coupled to the other element, or intervening elements may be present between them. On the other hand, when an element is referred to as being “directly connected” or “directly coupled” to another element, it should be understood that there are no intervening elements present between them. Expressions describing a relationship between elements, such as “between,” “directly between,” or “directly adjacent to,” should be interpreted in the same manner.

The terminology used in the present specification is intended only to describe specific embodiments and is not intended to limit the present invention. Singular expressions include plural expressions unless the context clearly indicates otherwise. In the present specification, terms such as “include” or “have” are intended to specify that features, numbers, steps, operations, components, parts, or combinations thereof are present, but should be understood not to preclude the possibility that one or more other features, numbers, steps, operations, components, parts, or combinations thereof may also be present or added.

Unless otherwise defined, all terms used herein, including technical and scientific terms, have the same meanings as commonly understood by one of ordinary skill in the art to which the present invention pertains. Terms that are defined in generally used dictionaries are to be interpreted as having meanings consistent with the contextual meaning in the relevant art and are not to be interpreted in an idealized or overly formal sense unless explicitly defined in the present specification.

Hereinafter, embodiments will be described in detail with reference to the accompanying drawings. However, the scope of the present patent application is not limited or restricted by these embodiments. The same reference numerals presented in each drawing indicate the same components.

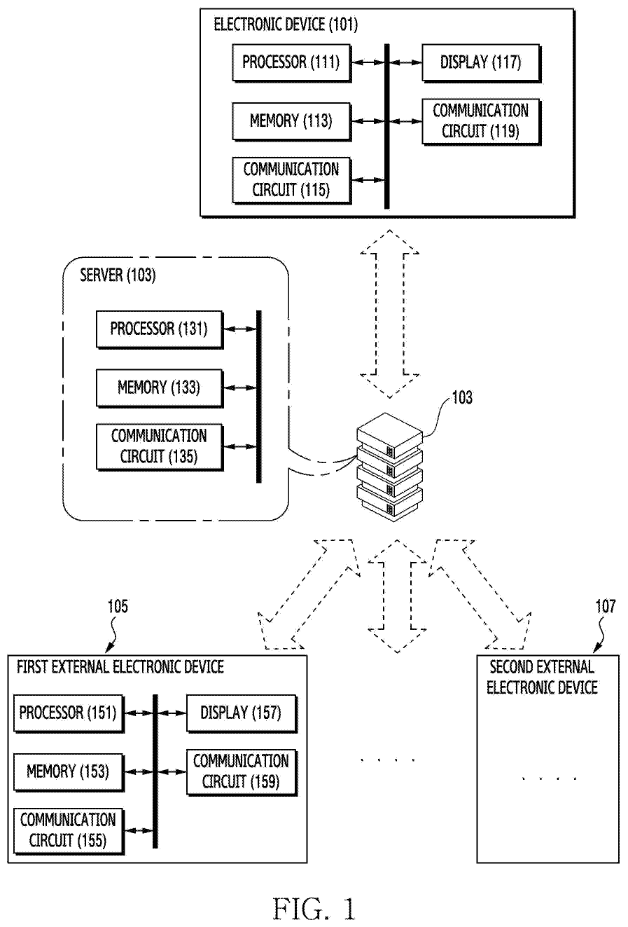

FIG. 1 is an exemplary block diagram of an electronic device in a network environment, according to an embodiment.

Referring to FIG. 1, an environment illustrated in FIG. 1 may include an electronic device 101, a plurality of external electronic devices 105 and 107, and a server 103. The electronic device 101 and the plurality of external electronic devices 105 and 107 may be connected to each other based on a wired network and/or a wireless network. For example, the wired network may include a network such as the Internet, a local area network (LAN), a wide area network (WAN), Ethernet, or a combination thereof. The wireless network may include a network such as long term evolution (LTE), 5G new radio (NR), wireless fidelity (Wi-Fi), Zigbee, near field communication (NFC), Bluetooth, Bluetooth low-energy (BLE), or a combination thereof. In FIG. 1, the electronic device 101 is illustrated as being directly connected to the plurality of external electronic devices 105 and 107 through the server 103, but is not limited thereto. For example, the electronic device 101 and the plurality of external electronic devices 105 and 107 may be indirectly connected through one or more routers and/or one or more access points (APs).

The server 103 according to an embodiment may mean a server of a service provider. For example, the server 103 may register users of the electronic device 101 and the plurality of external electronic devices 105 and 107, which are client devices, based on linkage with a database storing information on a user subscribed to a service (e.g., a multimedia content service or a game service), or may execute authentication of a user based at least on a relationship between account information received from at least one (e.g., the electronic device 101) of the electronic device 101 and the plurality of external electronic devices 105 and 107 and account information stored in the database storing the user information. For example, the service may include a game service provided to users subscribed to the service. For example, the service may include a program, an application, and/or a library for providing the game service. For example, the server 103 may provide information on a virtual space associated with the game service to the electronic device 101 and the plurality of external electronic devices 105 and 107. The virtual space may indicate a virtual environment (or a game environment) implemented in the game service.

According to an embodiment, based on linkage with a database (e.g., memory 133 of the server 103) storing data for execution of a software application (e.g., a game software application) related to a service, the electronic device 101 may process a calculation request related to a software application received from the plurality of external electronic devices 105 and 107, which are client devices, and may transmit information on a result of the processing to the server 103. The calculation request related to the application received from the plurality of external electronic devices 105 and 107 may include avatar information corresponding to account information of each of users.

Referring to FIG. 1, the electronic device 101 according to an embodiment may include a personal computer such as a laptop and a desktop, a smartphone, a smart pad, a tablet personal computer (PC), and a smart accessory such as a smart watch and a head-mounted device (HMD). For example, the electronic device 101 may include at least one of a processor 111, memory 113, a communication circuit 115, a display 117, or a sensor 119. The processor 111, the memory 113, the communication circuit 115, the display 117, and/or the sensor 119 may be electronically and/or operably coupled with each other by an electronical component such as a communication bus. A type and/or the number of hardware components included in the electronic device 101 are not limited to those illustrated in FIG. 1. For example, the electronic device 101 may include only some of the hardware components illustrated in FIG. 1.

The processor 111 of the electronic device 101 according to an embodiment may include a hardware component for processing data based on one or more instructions. The hardware component for processing data may include, for example, an arithmetic and logic unit (ALU), a field programmable gate array (FPGA), and/or a central processing unit (CPU). The number of processors 111 may be one or more. For example, the processor 111 may have a structure of a multi-core processor such as a dual core, a quad core, or a hexa core.

According to an embodiment, the memory 113 of the electronic device 101 may include a hardware component for storing data and/or instructions input to and/or output from the processor 111. The memory 113 may include, for example, a volatile memory such as a random-access memory (RAM) and/or a non-volatile memory such as a read-only memory (ROM). The volatile memory may include, for example, at least one of a dynamic RAM (DRAM), a static RAM (SRAM), a Cache RAM, or a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, or an embedded multi media card (eMMC).

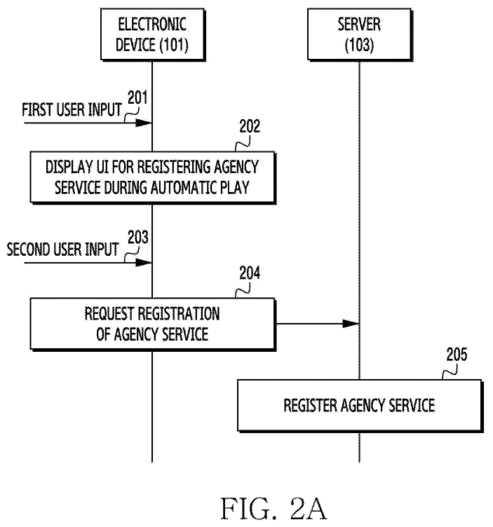

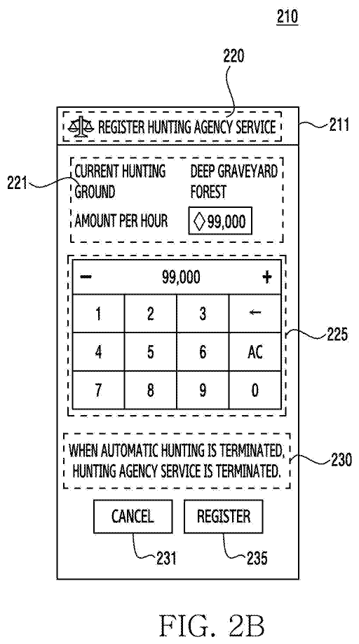

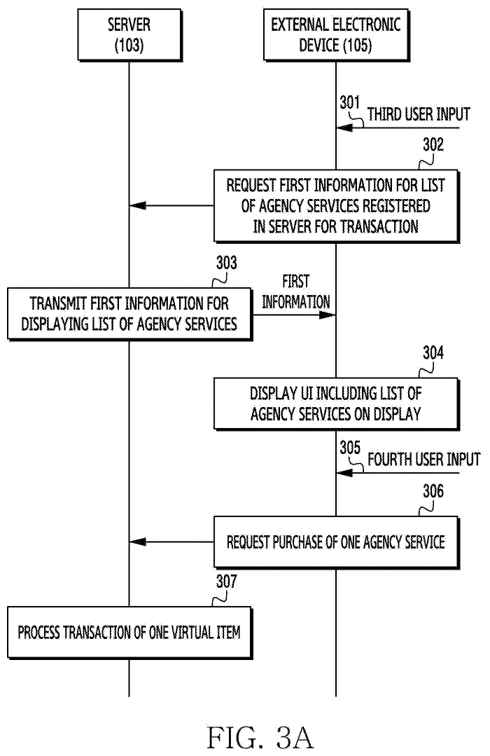

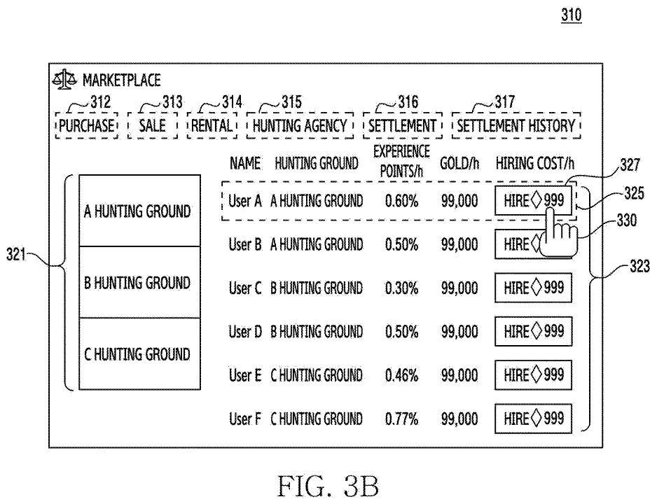

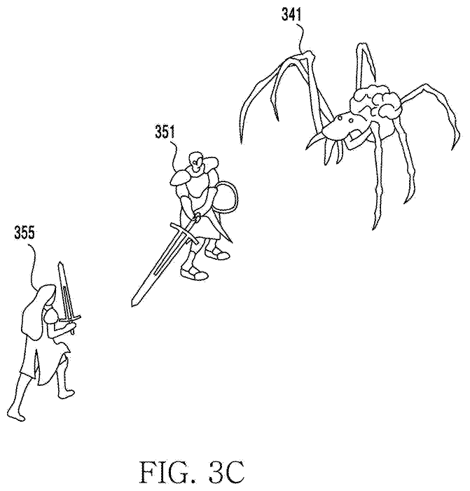

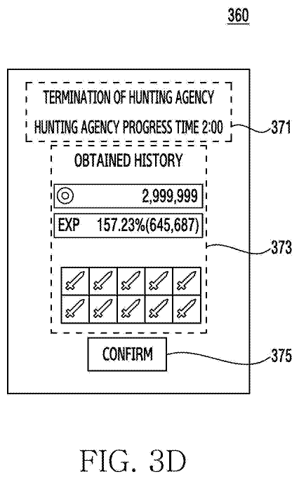

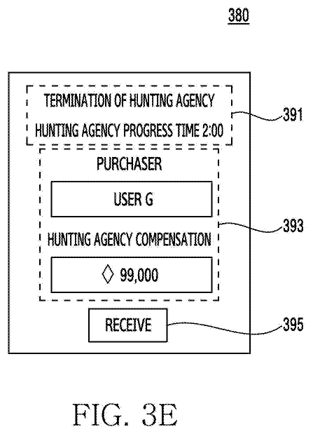

According to an embodiment, in the memory 113 of the electronic device 101, one or more instructions (or commands) indicating a calculation and/or an operation to be performed on data by the processor 111 of the electronic device 101 may be stored. A set of one or more instructions may be referred to as firmware, an operating system, a process, a routine, a sub-routine, and/or an application. For example, when a set of a plurality of instructions distributed in a form of an operating system, firmware, a driver, and/or an application is executed, the electronic device 101 and/or the processor 111 may perform at least one of operations of FIG. 2A or FIG. 3A. Hereinafter, an application being installed in the electronic device 101 may mean that one or more instructions provided in a form of an application are stored in the memory 113, and that one or more applications are stored in a format (e.g., a file having an extension designated by an operating system of the electronic device 101) executable by the processor 111. As an example, the application may include a program and/or a library related to a service provided to a user.

According to an embodiment, the communication circuit 115 of the electronic device 101 may include a hardware component for supporting transmission and/or reception of a signal between the electronic device 101 and the plurality of external electronic devices 105 and 107. The communication circuit 115 may include, for example, at least one of a MODEM, an antenna, or an optic/electronic (O/E) converter. For example, the communication circuit 115 may support transmission and/or reception of a signal based on various types of protocols such as Ethernet, a local area network (LAN), a wide area network (WAN), wireless fidelity (Wi-Fi), Bluetooth, Bluetooth low energy (BLE), ZigBee, long term evolution (LTE), and 5G new radio (NR).

According to an embodiment, the display 117 of the electronic device 101 may be controlled by a controller such as the processor 111 to output visualized information to the user. The display 117 may include a flat panel display (FPD) and/or electronic paper. The FPD may include a liquid crystal display (LCD), a plasma display panel (PDP), and/or one or more light emitting diodes (LEDs). The LED may include an organic LED (OLED). For example, the display 117 may be used to display an image obtained by the processor 111 or an image obtained by a display driving circuit. For example, the electronic device 101 may display an image on a portion of the display 117 according to control of the display driving circuit. However, it is not limited thereto. For example, the electronic device 101 may display, on the display 117, multimedia content including an avatar corresponding to the electronic device 101, based on receiving information on the multimedia content (e.g., a game screen) from the server 103.

According to an embodiment, the sensor 119 of the electronic device 101 may identify an input for the display 117. For example, the sensor 119 may identify the input on the display 117 by the user of the electronic device 101. For example, the input may include at least one of a touch input including a contact point with respect to at least a portion on the display 117, a drag input for the display 117, or a hovering input for the display 117. For example, the sensor 119 may detect an operation state (e.g., power or temperature) of the electronic device 101 according to the input or an external environment state (e.g., a user state), and generate an electrical signal or a data value corresponding to the detected state. For example, the sensor 119 may include a gesture sensor, a gyro sensor, a barometric pressure sensor, a magnetic sensor, an acceleration sensor, an inertial measurement unit (IMU) sensor, a grip sensor, a proximity sensor, a color sensor, an infrared (IR) sensor, a biometric sensor, a temperature sensor, a humidity sensor, or an illuminance sensor.

According to an embodiment, the server 103 may include at least one of a processor 131, the memory 133, and a communication circuit 135. The processor 131, the memory 133, or the communication circuit 135 may be electronically and/or operably coupled with each other by an electronical component such as a communication bus. A type and/or the number of hardware components included in the server 103 are not limited to those illustrated in FIG. 1. For example, the server 103 may include only some of the hardware components illustrated in FIG. 1. For example, the processor 131 may correspond to the processor 111 of the electronic device 101. For example, the memory 133 may correspond to the memory 113 of the electronic device 101. The communication circuit 135 may correspond to the communication circuit 115 of the electronic device 101. In order to reduce repetition of description, overlapping descriptions may be omitted.

The server 103 according to an embodiment may store, in the memory 133, account information of users subscribed to a service (e.g., a game service) based on the server 103. For example, the account information of the users may include player character (PC) information corresponding to the account information in the game service. In addition, for example, the account information of the users may include information on electronic devices owned by the users.

For example, the PC information may include stats of a PC, a level, a skill, and/or appearance information of the PC. For example, the PC may include a playable character that performs a designated action based on an input of a user related to account information (or an electronic device) corresponding to the PC. For example, the PC may be different from a non-player character (NPC) that the user may not manipulate. For example, the NPC may indicate a character preset by the server 103 providing the virtual space or at the time of designing the virtual space. For example, the NPC may perform an interaction with the PC. For example, the NPC may include a monster. For example, the PC and the NPC may be included in an object (or a target object) that may be a target of the interaction.

For example, the server 103 may identify an input of a user based on receiving at least one signal from at least one electronic device owned by the user of the electronic device 101 and/or the plurality of external electronic devices 105 and 107. The electronic device 101 and/or the server 103 may control the PC based on identifying the input of the user.

According to an embodiment, the server 103 may store, in the memory 133, item information in the service (e.g., the game service) based on the server 103. For example, the item information may include information on an item used by the PC in the game service (or the virtual space). For example, the item information may include stats of the item and/or appearance information of the item.

According to an embodiment, the plurality of external electronic devices 105 and 107 may be owned by different users. For example, the first external electronic device 105 and/or the second external electronic device 107 may include a personal computer such as a laptop and a desktop, a smartphone, a smart pad, a tablet personal computer (PC), and a smart accessory such as a smart watch and a head-mounted device (HMD). For example, the plurality of external electronic devices 105 and 107 may be an example of an electronic device receiving the service (e.g., the game service) through the server 103. Respective users using the first external electronic device 105 and/or the second external electronic device 107 may be subscribers to a service provided by the electronic device 101. Although only two external electronic devices 105 and 107 are illustrated in FIG. 1, an embodiment of the present disclosure is not limited thereto. For example, the server 103 may be connected to three or more external electronic devices.

Among the plurality of external electronic devices 105 and 107 according to an embodiment, the first external electronic device 105 may include at least one of a processor 151, memory 153, a communication circuit 155, a display 157, or a sensor 159. The processor 151, the memory 153, the communication circuit 155, the display 157, and/or the sensor 159 may be electronically and/or operably coupled with each other by an electronical component such as a communication bus. A type and/or the number of hardware components included in the first external electronic device 105 are not limited to those illustrated in FIG. 1. For example, the first external electronic device 105 may include only some of the hardware components illustrated in FIG. 1. For example, the processor 151 may correspond to the processor 111 of the electronic device 101. For example, the memory 153 may correspond to the memory 113 of the electronic device 101. The communication circuit 155 may correspond to the communication circuit 115 of the electronic device 101. The display 157 may correspond to the display 117 of the electronic device 101. The sensor 159 may correspond to the sensor 119 of the electronic device 101. In order to reduce repetition of description, overlapping descriptions may be omitted.

According to an embodiment, each (e.g., the second external electronic device 107) of the plurality of external electronic devices 105 and 107 may include at least some or all of components included in the first external electronic device 105. Each of the plurality of external electronic devices including the second external electronic device 107 may be independently configured by including at least some or all of the components included in the first external electronic device 105.

As described above, the electronic device 101 may register, in a marketplace, an agency service (or a boosting service) for the user of the external electronic devices 105 and 107 by using its PC. The user of the external electronic devices 105 and 107 may receive distribution (or sharing) of experience points and/or virtual goods obtained by the PC related to the electronic device 101 through automatic play by purchasing one agency service among one or more agency services registered in the marketplace. Accordingly, a device and method according to embodiments of the present disclosure may provide, to a low-experience user, a user experience that allows a low-experience user to more easily adapt to the virtual space and may allow a high-experience user to obtain an additional benefit, by connecting the low-experience user and the high-experience user to each other through the agency service. In addition, reliability of a transaction of each of the low-experience user and the high-experience user may be increased by allowing a contract for the agency service between the low-experience user and the high-experience user to be concluded on the virtual space.

FIG. 2A is a flow chart illustrating operations of an electronic device and a server according to an embodiment. FIG. 2B illustrates a UI displayed on a display of an electronic device according to an embodiment.

An operation of an electronic device 101 illustrated in FIG. 2A may be performed by the processor 111 of FIG. 1 executing instructions stored in memory (e.g., the memory 113 of FIG. 1). An operation of a server 103 illustrated in FIG. 2A may be performed by the processor 131 of FIG. 1 executing instructions stored in memory (e.g., the memory 133 of FIG. 1). Transmission and/or reception of information between the electronic device 101 and the server 103 may be performed via a communication circuit (e.g., the communication circuits 115 and 135 of FIG. 1).

Referring to FIG. 2A, in operation 201, the electronic device 101 may receive a first user input. According to an embodiment, the electronic device 101 may receive the first user input provided from a user of the electronic device 101. According to an embodiment, the electronic device 101 may receive the first user input during automatic play. According to an embodiment, the electronic device 101 may receive the first user input for displaying a user interface (UI) 210 for registering an agency service during the automatic play. For example, the automatic play may be play in which a PC is automatically manipulated without manipulation (or intervention) of a user. For example, the automatic play may be play in which a PC performs a designated action for growth of the PC (e.g., growth of stats, a level, and/or a skill) without manipulation (or intervention) of a user. For example, the agency service may also be referred to as a boosting service. For example, the agency service may also be referred to as a hunting agency service.

In operation 202, the electronic device 101 may display, on a display 117, the UI 210 including one or more items 220, 221, 225, 230, 231, and 235 based on receiving the first user input. The electronic device 101 may display, via the display 117, the UI 210 for registering sale of the agency service based on automatic play of the PC of the electronic device 101 being in progress.

Referring to FIG. 2B, the item 220 of the UI 210 may be an item for indicating content of a service provided by the UI 210. The item 221 of the UI 210 may be an item for indicating information for registering an agency service in a virtual marketplace. For example, the item 221 of the UI 210 may include information on a region (e.g., a current hunting ground or a deep graveyard forest) in which automatic play is currently being performed on a virtual space, and/or price information set by a seller for purchase of the agency service. The region in which the automatic play is currently being performed may be a place in which the agency service is provided. The region in which the automatic play is currently being performed may not be changed by an input of the user on the UI 210. However, it is not limited thereto. The region in which the automatic play is currently being performed may be changed by an input of the user on the UI 210. A price set for purchase of the agency service may be set based on virtual currency (or game money) used in the virtual space. For example, the information on the price of the agency service may be changed by an input of the user related to the item 225 on the UI 210. For example, the item 225 of the UI 210 may be an area for setting an amount for purchase of the agency service. For example, the item 225 of the UI 210 may include a button for increasing the amount and a button for decreasing the amount. For example, the item 225 of the UI 210 may include one or more number buttons for setting the amount. For example, the item 230 of the UI 210 may be an item for notifying a termination condition of the agency service. For example, the item 230 of the UI 210 may include text indicating that the agency service proceeds while the automatic play of the PC of the user of the electronic device 101 is in progress. For example, the item 231 may be a button for cancelling registration of the agency service. For example, the electronic device 101 may cease displaying the UI 210 based on obtaining a designated input for the item 231. For example, the item 235 may be a button for registration of the agency service. For example, the electronic device 101 may register the agency service in the virtual marketplace based on obtaining a second user input for the item 235.

Referring back to FIG. 2A, in operation 203, the electronic device 101 may receive the second user input for registration of the agency service. According to an embodiment, the electronic device 101 may receive the second user input for the item 235 for registration of the agency service among the one or more items 220, 221, 225, 230, 231, and 235 of the UI 210.

In operation 204, the electronic device 101 may request registration for the agency service to the server 103 by the second user input. For example, the request may include the information on the region (e.g., the current hunting ground or the deep graveyard forest) in which the PC of the user of the electronic device 101 is currently performing the automatic play, and/or the price information set by the seller for purchase of the agency service.

In operation 205, the server 103 may register the agency service in the virtual marketplace. The server 103 may register the agency service in the virtual marketplace while the PC of the electronic device 101 performs the automatic play. For example, when the automatic play of the PC of the electronic device 101 is terminated, the server 103 may deregister the agency service from the virtual marketplace. For example, the electronic device 101 may request the deregistration of the agency service to the server 103 based on the automatic play of the PC of the electronic device 101 being terminated.

As described above, through the UI 210, the electronic device 101 may register, in a marketplace, an agency service for a user of external electronic devices 105 and 107 by using its PC. The user of the external electronic devices 105 and 107 may receive distribution (or sharing) of experience points and/or virtual goods obtained by the PC related to the electronic device 101 through the automatic play by purchasing one agency service among one or more agency services registered in the marketplace. Accordingly, a device and a method according to embodiments of the present disclosure may provide, to a low-skilled (or low-experience) user, a user experience that allows the low-skilled (or low-experience) user to more easily adapt to the virtual space and may allow a high-skilled (or high-experience) user to obtain an additional benefit, by connecting the low-skilled (or low-experience) user and the high-skilled (or high-experience) user to each other through the agency service. In addition, reliability of a transaction of each of the low-skilled (or low-experience) user and the high-skilled (or high-experience) user may be increased by allowing a contract for the agency service between the low-skilled (or low-experience) user and the high-skilled (or high-experience) user to be concluded on the virtual space.

FIG. 3A is a flow chart illustrating operations of an external electronic device and a server according to an embodiment. FIG. 3B illustrates a UI displayed on a display of an external electronic device according to an embodiment. FIG. 3C illustrates a screen displayed on a display of an external electronic device according to an embodiment. FIG. 3D illustrates a UI displayed on a display of an external electronic device according to an embodiment. FIG. 3E illustrates a UI displayed on a display of an electronic device according to an embodiment.

An operation of a server 103 illustrated in FIG. 3A may be performed by the processor 131 of FIG. 1 executing instructions stored in memory (e.g., the memory 133 of FIG. 1). An operation of an external electronic device 105 illustrated in FIG. 3A may be performed by the processor 151 of FIG. 1 executing instructions stored in memory (e.g., the memory 153 of FIG. 1). Transmission and/or reception of information between the external electronic device 105 and the server 103 may be performed via a communication circuit (e.g., the communication circuits 155 and 135 of FIG. 1).

Referring to FIG. 3A, in operation 301, the external electronic device 105 may be configured to receive a third user input provided from a user of the external electronic device 105.

Referring to FIG. 3B, the third user input may be referred to as a user input for displaying, on a display 117, a list of one or more agency services 323 registered in the server 103 for a transaction. For example, the external electronic device 105 may request the list to the server 103 based on receiving the third user input for a designated key button to request displaying the list on the display 117 or the third user input for a designated visual object. However, it is not limited thereto. In an embodiment, the designated key button may include, for example, a physical button on a keyboard. In an embodiment, the designated visual object may include a user interface (UI) displayed on the display 117. For example, the request may be provided as at least a portion of a function such as an inventory, crafting, a shop, a collection, a marketplace, and the like provided in a virtual space service. For example, the request may be provided by being included in any function of the virtual space service that displays a virtual item on the display 117.

Referring back to FIG. 3A, in operation 302, the external electronic device 105 may request, to the server 103, first information for a list of agency services registered in the server 103 for a transaction, based on a first user input.

According to an embodiment, when executing instructions, the external electronic device 105 may be configured to request, to the server 103, the list of the agency services registered in the server 103 for the transaction in response to receiving the first user input. For example, the first information may be referred to as information for the external electronic device 105 to display the list on the display 117.

In operation 303, the server 103 may transmit, to the external electronic device 105, the first information for displaying the list of the agency services.

According to an embodiment, the server 103 may transmit, to the external electronic device 105, the first information for displaying the list of the one or more agency services 323 registered in the server 103 for the transaction, based on receiving the request for the first information from the external electronic device 105.

For example, the server 103 may provide a service for a transaction of an agency service. For example, the server 103 may include a virtual marketplace for the transaction of the agency service. Sellers may register an agency service to be sold in the virtual marketplace of the server 103, and purchasers may check and purchase the registered agency service. The first information for displaying the list of the one or more agency services (e.g., the one or more agency services 323 of FIG. 3B) that are targets of a sale may be referred to as information for displaying, on a display (e.g., a display 157 of FIG. 1) of the external electronic device 105, information related to each of the one or more boosting services 323 registered in the virtual marketplace (e.g., a name, a hunting ground, experience points, gold, and/or a price).

In operation 304, the external electronic device 105 may display, on the display 157, a user interface (UI) 310 including the list of the agency services, based on receiving the first information from the server 103.

According to an embodiment, the external electronic device 105 may display, on the display 157, the UI 310 including the list of the one or more agency services 323 registered in the server 103 for the transaction, by using the first information, based on receiving the first information from the server 103.

For example, the external electronic device 105 may be configured to display, on the display 117, the UI 310 including the list of the one or more agency services 323 registered in the virtual marketplace, based on the first information provided from the server 103. Referring to FIG. 3B, the UI 310 may include a list including information related to the one or more agency services 323 included in the first information.

According to an embodiment, the UI 310 may include a purchase field 312, a sale field 313, a rental field 314, a hunting agency field 315, a settlement field 316, and/or a settlement history field 317.

For example, the UI 310 may be changed according to an activated field. For example, while the purchase field 312 is activated, the UI 310 may display one or more items that may be purchased. For example, while the sale field 313 is activated, the UI 310 may display one or more items that may be sold via a PC of the user of the external electronic device 105. For example, while the sale field 313 is activated, the UI 310 may include a menu for the PC to perform registration for a sale of an item in the server 103. For example, while the rental field 314 is activated, the UI 310 may display one or more items that may be rented via the PC of the user of the external electronic device 105. For example, while the hunting agency field 315 is activated, the UI 310 may display one or more agency services that may be purchased. For example, while the settlement field 316 is activated, the UI 310 may include a menu for settling, between a purchaser and a seller, virtual goods (e.g., an item and/or gold) obtained while an agency service purchased via the PC of the user of the external electronic device 105 is in progress. For example, while the settlement history field 317 is activated, the UI 310 may include a menu for showing virtual goods (e.g., an item and/or gold) settled through the agency service purchased via the PC of the user of the external electronic device 105.

For example, while the hunting agency field 315 is activated, the UI 310 may include a list of one or more hunting regions 321. For example, while the hunting agency field 315 is activated, the UI 310 may include the list of the one or more agency services 323. For example, the list of the one or more agency services 323 of the UI 310 may include information on a name of a PC of a user who registered an agency service, a region in which the agency service is provided, experience points obtainable through the agency service, virtual goods obtainable through the agency service, and/or a cost required for use of the agency service.

Referring back to FIG. 3A, in operation 305, the external electronic device 105 may receive a fourth user input for selecting one agency service (e.g., one agency service 325 of FIG. 3B).

According to an embodiment, the external electronic device 105 may be configured to receive a fourth user input 330 for selecting the agency service 325 among the one or more agency services 323 in the list. The agency service 325 may be referred to as an agency service selected by the fourth user input 330 among the one or more agency services 323. For example, the fourth user input 330 may be referred to as a user input for a visual object 327 corresponding to the agency service 325 in the UI 310 illustrated in FIG. 3B. The external electronic device 105 may receive the fourth user input 330 for one visual object 327 corresponding to any one of the one or more agency services 323 that the user desires to purchase, among one or more visual objects.

In operation 306, the external electronic device 105 may request purchase of the selected agency service 325 to the server 103 by the fourth user input 330.

According to an embodiment, the external electronic device 105 may transmit information on the selected agency service 325 to the server 103, based on receiving the fourth user input 330.

In the operation 306, the external electronic device 105 may request purchase of the agency service 325 based on the fourth user input 330 selecting the visual object 327. For example, the external electronic device 105 may transmit, to the server 103, the request for the purchase of the agency service 325 based on the fourth user input 330 selecting the visual object 327. For example, the request may include identification information of the agency service 325, identification information of the user of the external electronic device 105, and/or account information.

In operation 307, the server 103 may process the purchase of the agency service 325. According to an embodiment, the server 103 may process a transaction of the agency service 325 based on receiving the purchase request for the agency service 325 from the external electronic device 105. For example, the server 103 may form a party between a purchaser's PC (355 of FIG. 3C) and a seller's PC (351 of FIG. 3C). For example, the party may be a contract for distributing (or sharing) virtual goods obtained during automatic play of the purchaser's PC 355 between the purchaser's PC 355 and the seller's PC 351. For example, the party may be a contract for distributing (or sharing) virtual goods obtained during automatic play of the seller's PC 351 between the purchaser's PC 355 and the seller's PC 351. For example, by the party between the purchaser's PC 355 and the seller's PC 351, virtual goods obtained by the seller's PC 351 hunting an NPC 341 through the automatic play may also be provided to the purchaser's PC 355.

For example, the server 103 may initiate the automatic play of the seller's PC to provide the agency service to the purchaser's PC, based on receiving the purchase request for the agency service 325 from the external electronic device 105.

For example, the server 103 may move the purchaser's PC to a periphery of the seller's PC based on receiving the purchase request for the agency service 325 from the external electronic device 105. For example, when the purchaser's PC is far away from the seller's PC (e.g., when hunting grounds are different from each other), the server 103 may move the purchaser's PC to the periphery of the seller's PC. For example, the server 103 may transmit, to external electronic device 105 and 107 of the purchaser, a command to move the PC to the periphery of the seller's PC. In an embodiment, based on purchasing the agency service of a user of the electronic device 101 through the server 103, the external electronic device 105 may move the PC of the external electronic device 105 to a region in which the agency service is provided during the automatic play of a PC of the electronic device 101. However, it is not limited thereto. For example, the server 103 may move the seller's PC to a periphery of the purchaser's PC based on receiving the purchase request for the agency service 325 from the external electronic device 105. For example, when the seller's PC is far away from the purchaser's PC (e.g., when hunting grounds are different from each other), the server 103 may move the seller's PC to the periphery of the purchaser's PC. For example, the server 103 may transmit, to the electronic device 101 of the seller, a command to move the PC to the periphery of the purchaser's PC. For example, based on the agency service sold to the user of the external electronic device 105 through the server 103, the electronic device 101 may move the PC of the electronic device 101 toward the PC of the external electronic device 105 in the region in which the agency service is provided, during the automatic play of the PC of the electronic device 101. However, it is not limited thereto. For example, the electronic device 101 may provide the agency service to the purchaser's PC regardless of whether the purchaser's PC is located in the region in which the agency service is provided. For example, even when the seller's PC is far away from the purchaser's PC (e.g., when hunting grounds are different from each other) (or when the purchaser's PC is not located in the region in which the agency service is provided), the server 103 may not move the purchaser's PC to the seller's PC. For example, even when the seller's PC is far away from the purchaser's PC (e.g., when hunting grounds are different from each other) (or when the seller's PC is not located in the region in which the agency service is provided), the server 103 may not move the seller's PC to the purchaser's PC. For example, even when the seller's PC is far away from the purchaser's PC (e.g., when hunting grounds are different from each other) (or when the purchaser's PC is not located in the region in which the agency service is provided), the server 103 may initiate the automatic play of the seller's PC to provide the agency service to the purchaser's PC.

For example, the server 103 may provide the agency service 325 to the purchaser's PC 355 during the automatic play of the seller's PC 351. For example, the server 103 may provide the agency service 325 to the purchaser's PC 355 for a time purchased by the purchaser's PC 355.

For example, the electronic device 101 may control the PC to be positioned between a non-PC (NPC) and the PC of the external electronic device 105 such that the PC of the electronic device 101 defends against an attack of the NPC on the PC of the external electronic device 105 during the automatic play. For example, the external electronic device 105 may control the PC of the external electronic device 105 to be farther away from the NPC than the PC of the electronic device 101 such that the PC of the electronic device 101 defends against the attack of the NPC on the PC of the external electronic device 105 during the automatic play.

For example, the electronic device 101 may obtain, via the seller's PC, virtual goods and experience points for growing the seller's PC during the automatic play of the seller's PC, while providing the agency service to the purchaser's PC. Based on the agency service being terminated, the obtained virtual goods and the experience points may be distributed (or shared) between the seller's PC and the purchaser's PC. Based on the agency service being terminated, a payment corresponding to the agency service may be transferred from the purchaser's PC to the seller's PC through the server 103. For example, the agency service may be terminated based on the automatic play of the PC being terminated. However, it is not limited thereto.

For example, the obtained virtual goods and the experience points may be delivered (or withdrawn, or transferred) from the seller's PC while the agency service is provided to the purchaser's PC. For example, the obtained virtual goods and the experience points may be delivered (or withdrawn) (or transferred) from the seller's PC according to a designated condition while the agency service is provided to the purchaser's PC. In an embodiment, the designated condition may be based on a distribution period, a quantity of the obtained virtual goods, an amount of the obtained experience points, intermediate termination of the agency service, and/or communication connection of the electronic devices 101 and 105 to the server 103. For example, the obtained virtual goods and the experience points may be delivered (or withdrawn) (or transferred) from the seller's PC for every designated distribution period (or in real time). For example, the obtained virtual goods and the experience points may be delivered (or withdrawn) (or transferred) from the seller's PC whenever virtual goods in an undistributed state exceed a designated quantity of virtual goods. For example, the obtained virtual goods and the experience points may be delivered (or withdrawn) (or transferred) from the seller's PC whenever experience points in an undistributed state exceed a designated amount of experience points. For example, the obtained virtual goods and the experience points may be delivered (or withdrawn) (or transferred) from the seller's PC when the agency service is intermediately terminated by the seller and/or the purchaser. In an embodiment, the virtual goods and the experience points delivered (or withdrawn) (or transferred) from the seller's PC may be distributed between the seller's PC and the purchaser's PC. In an embodiment, the virtual goods and the experience points delivered (or withdrawn) (or transferred) from the seller's PC may be distributed between the seller's PC and the purchaser's PC based on the agency service being terminated. In an embodiment, the virtual goods and the experience points delivered (or withdrawn) (or transferred) from the seller's PC may be stored in the server 103 (or an account designated by the seller's PC, the purchaser's PC, and/or the server 103). In an embodiment, the stored virtual goods and the experience points may be distributed between the seller's PC and the purchaser's PC simultaneously with (or substantially simultaneously with) settlement of a payment corresponding to a time for which the agency service is provided. In an embodiment, the stored virtual goods and the experience points may be distributed between the seller's PC and the purchaser's PC based on the agency service being terminated. In an embodiment, the stored virtual goods and the experience points may be distributed between the seller's PC and the purchaser's PC based on the agency service being intermediately terminated. In an embodiment, intermediate termination of the agency service may refer to termination before a termination time point scheduled at a time of a transaction of the agency service.

For example, the payment corresponding to the agency service may be delivered (or withdrawn) (or transferred) from the purchaser's PC while the agency service is provided to the purchaser's PC. For example, the payment corresponding to the agency service may be delivered (or withdrawn) (or transferred) from the purchaser's PC according to a designated condition while the agency service is provided to the purchaser's PC. In an embodiment, the designated condition may be based on a distribution period, purchase of the agency service, intermediate termination of the agency service, and/or communication connection of the electronic devices 101 and 105 to the server 103. For example, the payment corresponding to the agency service may be delivered (or withdrawn) (or transferred) from the purchaser's PC for every designated distribution period (or in real time). For example, the payment corresponding to the agency service may be delivered (or withdrawn) (or transferred) from the purchaser's PC when the purchaser's PC purchases the agency service. For example, the payment corresponding to the agency service may be delivered (or withdrawn) (or transferred) from the purchaser's PC when the agency service is intermediately terminated by the seller and/or the purchaser. For example, the payment corresponding to the agency service may be delivered (or withdrawn) (or transferred) from the purchaser's PC when connection of the electronic devices 101 and 105 of the seller and/or the purchaser to the server 103 is released (or login is released) (or access is released). In an embodiment, the payment delivered (or withdrawn) (or transferred) from the purchaser's PC may be directly (or in real time) transferred to the seller's PC. In an embodiment, the payment delivered (or withdrawn) (or transferred) from the purchaser's PC may be transferred to the seller's PC based on the agency service being terminated. In an embodiment, the payment delivered (or withdrawn) (or transferred) from the purchaser's PC may be stored in the server 103 (or an account designated by the seller's PC, the purchaser's PC, and/or the server 103). In an embodiment, a portion of payment corresponding to a time for which the agency service is provided among the stored payment may be transferred to the seller's PC simultaneously with (or substantially simultaneously with) settlement of the virtual goods and the experience points. In an embodiment, the stored payment may be transferred to the seller's PC based on the agency service being terminated. In an embodiment, the portion of the payment corresponding to the time for which the agency service is provided among the stored payment may be transferred to the seller's PC based on the agency service being intermediately terminated.

For example, when provision of the agency service 325 is completed, the server 103 may display, via the display 157 of the external electronic device 105 corresponding to the purchaser's PC 355, a UI (360 of FIG. 3D) for guiding termination of hunting agency. Referring to FIG. 3D, the UI 360 may include one or more items 371, 373, and 375. For example, the item 371 may include a phrase for guiding termination of the agency service and/or a phrase for guiding a time for which the agency service is provided. For example, the item 373 may include a phrase for guiding virtual goods (e.g., an item and/or gold) and/or experience points obtained during the agency service. For example, the item 375 may be a button to cease displaying the UI 360. For example, the external electronic device 105 may cease displaying the UI 360 based on obtaining a designated input for the item 375.

For example, when provision of the agency service 325 is completed, the server 103 may display, via the display 117 of the electronic device 101 corresponding to the seller's PC 351, a UI (380 of FIG. 3E) for guiding termination of hunting agency. Referring to FIG. 3E, the UI 380 may include one or more items 391, 393, and 395. For example, the item 391 may include a phrase for guiding termination of the agency service and/or a phrase for guiding a time for which the agency service is provided. For example, the item 393 may include information on a purchaser to which the agency service is provided and a phrase for guiding compensation obtained during the agency service. For example, the item 395 may be a button to cease displaying the UI 380. For example, the electronic device 101 may cease displaying the UI 380 based on obtaining a designated input for the item 395.

As described above, through a UI 210, the electronic device 101 may register, in a marketplace, an agency service for a user of the external electronic devices 105 and 107 by using its PC. The user of the external electronic devices 105 and 107 may receive distribution (or sharing) of experience points and/or virtual goods obtained in a region beyond a capability of its PC by purchasing one agency service among one or more agency services registered in the marketplace. Accordingly, a device and a method according to embodiments of the present disclosure may provide, to a low-skilled (or low-experience) user, a user experience that allows the low-skilled (or low-experience) user to more easily adapt to a virtual space and may allow a high-skilled (or high-experience) user to obtain an additional benefit, by connecting the low-skilled (or low-experience) user and the high-skilled (or high-experience) user to each other through the agency service. In addition, reliability of a transaction of each of the low-skilled (or low-experience) user and the high-skilled (or high-experience) user may be increased by allowing a contract for the agency service between the low-skilled (or low-experience) user and the high-skilled (or high-experience) user to be concluded on the virtual space.

As described above, an electronic device may comprise a display, a communication circuit, and a processor. The processor may be configured to display, via the display, a user interface (UI) for registering a sale of an agency service for another player character (PC) of another user by a PC corresponding to a user of the electronic device. The processor may be configured to, based on receiving a user input for registering, in a server, the agency service including information on a region in a virtual space provided through the server in which the agency service is provided and/or information on a price of the agency service, request, via the communication circuit, the server to register the agency service in a marketplace including a list of one or more agency services, for a transaction of the agency service.

The processor may be configured to, based on the agency service sold to the another user of another electronic device through the server, initiate automatic play of the PC to provide the agency service to the another PC.

The processor may be configured to obtain, via the PC, virtual goods and experience points for growing the PC while providing the agency service to the another PC. The obtained virtual goods and the experience points may be distributed (or shared) between the PC and the another PC. A payment corresponding to the agency service may be configured to be transferred from the another PC to the PC.

The obtained virtual goods and the experience points may be distributed between the PC and the another PC while the agency service is provided to the another PC. The payment corresponding to the agency service may be transferred from the another PC to the PC while the agency service is provided to the another PC.

The obtained virtual goods and the experience points may be distributed between the PC and the another PC based on the agency service being terminated. The payment corresponding to the agency service may be transferred from the another PC to the PC based on the agency service being terminated.

The obtained virtual goods and the experience points may be transferred to a designated account while the agency service is provided to the another PC. The payment corresponding to the agency service from the another PC may be transferred to the designated account while the agency service is provided to the another PC. The obtained virtual goods and the experience points transferred to the designated account may be distributed between the PC and the another PC based on the agency service being terminated. The payment transferred to the designated account may be transferred to the PC based on the agency service being terminated.

The processor may be configured to, during the automatic play, control the PC to be positioned between a non-PC (NPC) and the another PC such that the PC defends against an attack of the NPC on the another PC.

The processor may be configured to, based on the agency service sold to the another user of the another electronic device through the server, move the PC toward the another PC within the region in which the agency service is provided during the automatic play.

The agency service may be provided to the another PC regardless of whether the another PC is located in the region in which the agency service is provided.

The agency service may be configured to be terminated based on the automatic play of the PC being terminated.

The processor may be configured to, based on receiving, via the display, a user input for requesting display of the UI for registering the sale of the agency service, identify whether automatic play of the PC is in progress. The processor may be configured to, based on the automatic play of the PC being in progress, display, via the display, the UI for registering the sale of the agency service.

The processor may be configured to, based on the automatic play of the PC being terminated, request deregistration of the agency service to the server.

The information on the price of the agency service may be changed by an input of the user on the UI.

The marketplace may include a field for displaying the list of the one or more agency services and a field for displaying a settlement result of the agency service.

As described above, a method performed by an electronic device may comprise displaying, via a display of the electronic device, a user interface (UI) for registering a sale of an agency service for another player character (PC) of another user by a PC corresponding to a user of the electronic device. The method may comprise, based on receiving a user input for registering, in a server, the agency service including information on a region in a virtual space provided through the server in which the agency service is provided and/or information on a price of the agency service, requesting, via a communication circuit of the electronic device, the server to register the agency service in a marketplace including a list of one or more agency services, for a transaction of the agency service.

The method may comprise, based on the agency service sold to the another user of another electronic device through the server, initiating automatic play of the PC to provide the agency service to the another PC.

The method may comprise obtaining, via the PC, virtual goods of the PC and experience points for growing the PC while providing the agency service to the another PC. The obtained virtual goods and the experience points may be distributed (or shared) between the PC and the another PC. A payment corresponding to the agency service may be configured to be transferred from the another PC to the PC.

The obtained virtual goods and the experience points may be distributed between the PC and the another PC while the agency service is provided to the another PC. The payment corresponding to the agency service may be transferred from the another PC to the PC while the agency service is provided to the another PC.

The obtained virtual goods and the experience points may be distributed between the PC and the another PC based on the agency service being terminated. The payment corresponding to the agency service may be transferred from the another PC to the PC based on the agency service being terminated.

The obtained virtual goods and the experience points may be transferred to a designated account while the agency service is provided to the another PC. The payment corresponding to the agency service from the another PC may be transferred to the designated account while the agency service is provided to the another PC. The obtained virtual goods and the experience points transferred to the designated account may be distributed between the PC and the another PC based on the agency service being terminated. The payment transferred to the designated account may be transferred to the PC based on the agency service being terminated.

The method may comprise, during the automatic play, controlling the PC to be positioned between a non-PC (NPC) and the another PC such that the PC defends against an attack of the NPC on the another PC.

The method may comprise, based on the agency service sold to the another user of the another electronic device through the server, moving the PC toward the another PC within the region in which the agency service is provided during the automatic play.

The agency service may be provided to the another PC regardless of whether the another PC is located in the region in which the agency service is provided.

The agency service may be configured to be terminated based on the automatic play of the PC being terminated.

The method may comprise, based on receiving, via the display, a user input for requesting display of the UI for registering the sale of the agency service, identifying whether automatic play of the PC is in progress. The method may comprise, based on the automatic play of the PC being in progress, displaying, via the display, the UI for registering the sale of the agency service.

The method may comprise, based on the automatic play of the PC being terminated, requesting deregistration of the agency service to the server.

The information on the price of the agency service may be changed by an input of the user on the UI.

The marketplace may include a field for displaying the list of the one or more agency services and a field for displaying a settlement result of the agency service.

As described above, an electronic device may comprise a display, a communication circuit, and a processor. The processor may display, via the display, a user interface (UI) including a list of one or more agency services registered in a server for a transaction, on a screen including at least a portion of a virtual space including a player character (PC) corresponding to a user of the electronic device. The processor may be configured to receive a user input for purchasing one agency service among the one or more agency services in the list. The processor may be configured such that the PC receives the agency service via another PC of another user who registered the agency service, based on receiving the user input.

The processor may be configured to, based on purchasing the agency service of the another user through the server, initiate automatic play of the PC while receiving the agency service via the another PC.

While the PC receives the agency service via the another PC, virtual goods obtained via the another PC and experience points for growing the PC may be distributed (or shared) between the another PC and the PC.

The processor may be configured to, during the automatic play, control the PC to be farther away from a non-PC (NPC) than the another PC such that the another PC defends against an attack of the NPC on the PC.

The processor may be configured to, based on purchasing the agency service of the another user through the server, move the PC to a region in which the agency service is provided during the automatic play.

The agency service may be configured to be terminated based on the automatic play of the another PC being terminated.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Therefore, other implementations, other embodiments, and those equivalent to the scope of the claims are in the scope of the claims described later. According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is

1. An electronic device comprising:
a display;
a communication circuit; and
a processor,
wherein the processor is configured to:
display, via the display, a user interface (UI) for registering a sale of service for another player character (PC) of another user by a PC corresponding to a user of the electronic device; and
based on receiving a user input for registering, in a server, the agency service including information on a region in a virtual space provided through the server in which the agency service is provided and/or information on a price of the agency service, request, via the communication circuit, the server to register the agency service in a marketplace including a list of one or more agency services, for a transaction of the agency service.

2. The electronic device of claim 1,
wherein the processor is configured to:
based on the agency service sold to the another user of another electronic device through the server, initiate automatic play of the PC to provide the agency service to the another PC.

3. The electronic device of claim 1,
wherein the processor is configured to:
obtain, via the PC, virtual goods and experience points for growing the PC while providing the agency service to the another PC,
wherein the obtained virtual goods and the experience points are distributed between the PC and the another PC, and
wherein a payment corresponding to the agency service is transferred from the another PC to the PC.

4. The electronic device of claim 3,
wherein the obtained virtual goods and the experience points are distributed between the PC and the another PC while the agency service is provided to the another PC, and
wherein the payment corresponding to the agency service is transferred from the another PC to the PC while the agency service is provided to the another PC.

5. The electronic device of claim 3,
wherein the obtained virtual goods and the experience points are distributed between the PC and the another PC based on the agency service being terminated, and
wherein the payment corresponding to the agency service is transferred from the another PC to the PC based on the agency service being terminated.

6. The electronic device of claim 3,
wherein the obtained virtual goods and the experience points are transferred to a designated account while the agency service is provided to the another PC,
wherein the payment corresponding to the agency service from the another PC is transferred to the designated account while the agency service is provided to the another PC,
wherein the obtained virtual goods and the experience points transferred to the designated account are distributed between the PC and the another PC based on the agency service being terminated, and
wherein the payment transferred to the designated account is transferred to the PC based on the agency service being terminated.

7. The electronic device of claim 2,
wherein the processor is configured to:
during the automatic play, control the PC to be positioned between a NPC(non-PC) and the another PC such that the PC defends against an attack of the NPC on the another PC.

8. The electronic device of claim 2,
wherein the processor is configured to:
based on the agency service sold to the another user of the another electronic device through the server, move the PC toward the another PC within the region in which the agency service is provided during the automatic play.

9. The electronic device of claim 2,
wherein the agency service is provided to the another PC regardless of whether the another PC is located in the region in which the agency service is provided.

10. The electronic device of claim 2,
wherein the agency service is configured to be terminated based on the automatic play of the PC being terminated.

11. The electronic device of claim 1,
wherein the processor is configured to:
based on receiving, via the display, a user input for requesting display of the UI for registering the sale of the agency service, identify whether automatic play of the PC is in progress; and
based on the automatic play of the PC being in progress, display, via the display, the UI for registering the sale of the agency service.

12. The electronic device of claim 11,
wherein the processor is configured to:
based on the automatic play of the PC being terminated, request deregistration of the agency service to the server.

13. The electronic device of claim 1,
wherein the information on the price of the agency service is changed by an input of the user on the UI.

14. The electronic device of claim 1,
wherein the marketplace includes a field for displaying the list of the one or more agency services and a field for displaying a settlement result of the agency service.

15. A method performed by an electronic device, the method comprising,
displaying, via a display of the electronic device, a user interface (UI) for registering a sale of an agency service for another player character (PC) of another user by a PC corresponding to a user of the electronic device; and
based on receiving a user input for registering, in a server, the agency service including information on a region in a virtual space provided through the server in which the agency service is provided and/or information on a price of the agency service, requesting, via a communication circuit of the electronic device, the server to register the agency service in a marketplace including a list of one or more agency services, for a transaction of the agency service.

16. The method of claim 15, the method comprising,
based on the agency service sold to the another user of another electronic device through the server, initiating automatic play of the PC to provide the agency service to the another PC.

17. The method of claim 15, the method comprising,
obtaining, via the PC, virtual goods and experience points for growing the PC while providing the agency service to the another PC,
wherein the obtained virtual goods and the experience points are distributed between the PC and the another PC, and
wherein a payment corresponding to the agency service is transferred from the another PC to the PC.

18. The method of claim 17,
wherein the obtained virtual goods and the experience points are distributed between the PC and the another PC while the agency service is provided to the another PC, and
wherein the payment corresponding to the agency service is transferred from the another PC to the PC while the agency service is provided to the another PC.

19. The method of claim 17,
wherein the obtained virtual goods and the experience points are distributed between the PC and the another PC based on the agency service being terminated, and
wherein the payment corresponding to the agency service is transferred from the another PC to the PC based on the agency service being terminated.

20. The method of claim 17,
wherein the obtained virtual goods and the experience points are transferred to a designated account while the agency service is provided to the another PC,
wherein the payment corresponding to the agency service from the another PC is transferred to the designated account while the agency service is provided to the another PC,
wherein the obtained virtual goods and the experience points transferred to the designated account are distributed between the PC and the another PC based on the agency service being terminated, and
wherein the payment transferred to the designated account is transferred to the PC based on the agency service being terminated.
